(19) United States
(12) Patent Application Publication
(10) Pub. No.: US 2008/0055321 A1
(43) Pub. Date: Mar. 6, 2008

(54) Parallel physics simulation and graphics processing

(75) Inventor: Rajabali M. Koduri, Santa Clara, CA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: ATI Technologies Inc., Markham (CA)

(21) Appl. No.: 11/513,389

(22) Filed: Aug. 31, 2006

(51) Int. Cl. G06F 15/80

(52) U.S. Cl. 345/505

(57) ABSTRACT

Embodiments of the present invention are directed to a method and computer program product for performing physics simulations and graphics processing on at least one graphics processor unit (GPU). Such a method for performing physics simulations and graphics processing on at least one GPU includes the following steps. First, physics simulations are executed on a first device embodied in the at least one GPU. Then, graphics are processed on a second device embodied in the at least one GPU responsive to the physics simulations executed on the first device. In an embodiment, the first device and second device are embodied on a single GPU. In another embodiment, the first device is embodied on a first GPU and the second device is embodied on a second GPU.

### BACKGROUND OF THE INVENTION

1. Field of the Invention

The present invention is generally directed to graphics processing.

2. Background Art

An application, such as a video game, running on a computer system may require both physics simulations and graphics processing. For example, a typical pipeline for computing and displaying the motion of one or more characters depicted in a scene of a video game includes a physics simulation step and a graphics processing step. In the physics simulation step, physics simulations are performed to determine the motion of the one or more characters depicted in the scene. Then in the graphics processing step, the results of the physics simulations are graphically processed for visualization by an end-user.

The physics simulation step is typically performed by a physics engine that is executed on a central processing unit (CPU) or a dedicated device of the computer system. In contrast, the graphics processing step is typically performed by a graphics processor unit (GPU). Ultimately, however, the results produced by the physics engine are used to modify the graphics of the application (e.g., video game), and therefore will be passed to the GPU in some form. Because the results from the physics engine must be passed to the GPU for processing, latency and bandwidth problems may arise. Furthermore, as a general processing unit, a CPU does not possess the parallel processing capabilities of a GPU.

Given the foregoing, what is needed is a method, computer program product, and system for performing physics simulations on one or more GPUs.

### BRIEF SUMMARY OF THE INVENTION

Embodiments of the present invention meet the above-identified needs by providing a method, computer program product, and system for simultaneous physics simulation and graphics processing.

In accordance with an embodiment of the present invention there is provided a method for simultaneously performing physics simulations and graphics processing on at least one graphics processor unit (GPU). This method includes the following features. Physics simulations are executed on a first device embodied in the at least one GPU. Graphics are processed on a second device embodied in the at least one GPU responsive to the physics simulations executed on the first device. In an embodiment, the first device and second device are embodied on a single GPU. In another embodiment, the first device is embodied on a first GPU and the second device is embodied on a second GPU.

In accordance with another embodiment of the present invention there is provided a computer readable medium containing instructions for generating at least one GPU which when executed are adapted to create the at least one GPU. The at least one GPU is adapted to perform the following functions: (i) execute physics simulations on a first device embodied in the at least one GPU; and (ii) process graphics on a second device embodied in the at least one GPU responsive to the physics simulations executed on the first device. In an embodiment, the first device and second device are embodied on a single GPU. In another embodiment, the first device is embodied on a first GPU and the second device is embodied on a second GPU.

In accordance with a further embodiment of the present invention there is provided a computer program product comprising computer usable medium having control logic stored therein for causing physics simulations and graphics processing to be performed on at least one GPU. The control logic includes first and second computer readable code. The first computer readable code causes the at least one GPU to execute physics simulations on a first device embodied in the at least one GPU. The second computer readable code causes the at least one GPU to process graphics on a second device embodied in the at least one GPU responsive to the physics simulations executed on the first device.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 depicts a block diagram of an example functional block diagram of a system for simultaneously performing physics simulations and graphics processing on at least one GPU in accordance with an embodiment of the present invention.

FIG. 2 depicts a block diagram illustrating an example system for performing physics simulations and graphics processing on one or more GPU in accordance with an embodiment of the present invention.

FIG. 3 depicts a block diagram illustrating an example memory mapping scheme in accordance with an embodiment of the present invention.

FIG. 4 depicts a block diagram illustrating an example command synchronization in accordance with an embodiment of the present invention.

FIG. 5 depicts a block diagram of an example GPU architecture for simultaneously performing physics simulations and graphics processing in accordance with an embodiment of the present invention.

FIG. 6 depicts a block diagram of an example computer system in which an embodiment of the present invention may be implemented.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

Many GPUs today are capable of performing general purpose computing operations, and are not limited to graphics rendering operations alone. A GPU that performs general purpose computing is generally referred to as a general-purpose GPU (GPGPU). There are varieties of opportunities for GPGPU applications and algorithms. One such application is in the area of game physics processing. Performing realistic, dynamic physics simulations in games is widely considered as the next frontier in computer gaming.

Game physics processing workloads are considerably different than the graphics rendering workloads. Described in more detail herein are salient differences between the workloads in the context of multi-GPU systems.

Embodiments of the present invention are directed to a method and computer program product for simultaneously performing physics simulations and graphics processing on at least one GPU. Such simultaneous physics simulations and graphics processing capabilities may be used, for example, by an application (such as a video game) for performing game computing. Described in more detail herein is an embodiment in which the simultaneous physics simulations and graphics processing capabilities are provided to an application as an extension to a typical graphics application programming interface (API), such as DirectX® or OpenGL®. In such an embodiment, physics simulations are performed by a first device embodied in at least one GPU and graphics processing is performed by a second device embodied in the at least one GPU responsive to the physics simulations.

In an embodiment, physics simulations are performed on a first GPU and graphics processing is performed on a second GPU. Performing physics simulations is an iterative process. The data from each physics processing step are carried forward to the next step. Including a dedicated physics processing GPU (e.g., the first GPU) allows for physics step-to-step shared simulation data to reside in the local memory of the dedicated physics processing GPU, without the need to synchronize this data between graphics processing GPU(s) (e.g., the second GPU).

The physics processing step performed by the first GPU also computes the positions of the objects that usually serve as input to the graphics processing step performed by the second GPU. These positions computed by the first GPU-referred to herein as object position data—is typically low bandwidth, making it well-suited for transmission over a PCIE bus. As a result, the physics simulations may be executed on the first GPU in parallel with the graphics processing executed on the second GPU.

Embodiments of the present invention provide an application with several capabilities associated with simultaneously performing physics simulations and graphics processing. For example, the application may designate a physics thread in which physics simulations are performed and a graphics thread in which graphics processing is performed. As another example, the application may set a schedule for the performance of physics simulations and graphics processing. As a further example, the application may move data between a physics thread and a graphics thread. As a further example, the application may allocate a shared surface (i.e., a physics device and a graphics device may have access to a common pool of memory). As a still further example, the application may synchronize activities between physics simulations executed on a first GPU and graphics processing executed on a second GPU.

It is noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

As mentioned above, conventionally physics simulations tasks are performed by a physics engine embodied in a CPU or dedicated hardware and graphics processing tasks are performed by a GPU, which may result in latency issues when the physics simulation results are transferred to the GPU for graphics processing. Embodiments of the present invention circumvent such latency issues by providing a method and computer program product for performing physics simulations and graphics processing on one or more GPUs. In addition, by performing physics simulations on a GPU, the parallel compute capabilities of the GPU can be utilized. Such capabilities are not present on a CPU. Thus, physics simulations can be computed faster on a GPU than they can be computed on a CPU.

In an embodiment, the physics simulations and graphics processing are performed by a single GPU. Such an embodiment reduces the amount of data traffic that must pass between the CPU and the GPU(s)—and thereby mitigates problems associated with the latency and bandwidth issues discussed above. In this embodiment, the physics simulations and the graphics processing are performed in a “time sliced” manner. That is, the physics simulations and graphics processing tasks are executed sequentially on the GPU compute resources, not simultaneously. From an application point of view, however, the physics and graphics tasks appear to be executed simultaneously as multi-threads.

In another embodiment, the physics simulations are executed on a first GPU and the graphics processing is executed on a second GPU. In this embodiment, the physics simulations and the graphics processing are performed in a task sliced manner. That is, the physics simulations and the graphics processing tasks are executed simultaneously, not sequentially.

Described in more detail below are an example functional block diagram and system for simultaneously performing physics simulations and graphics processing on one or more GPUs in accordance with an embodiment of the present invention.

### II. An Example Functional Block Diagram of a System for Simultaneously Performing Physics Simulations and Graphics Processing on One or More GPUs In Accordance with an Embodiment of the Present Invention

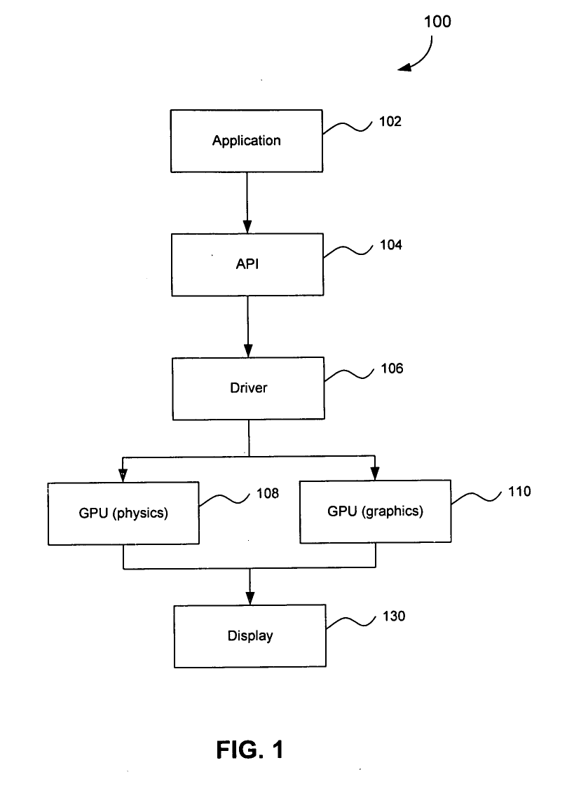

FIG. 1 depicts a block diagram 100 of an example functional block diagram of a system for performing physics simulations and graphics processing on at least one GPU. Block diagram 100 includes various software elements, such as an application 102, application programming interface (API) 104, and a driver 106, that are executed on a host computer system and interact with graphics hardware elements—such as a GPU 108, a GPU 110, and/or a plurality of other GPUs (not shown)—to perform physics simulations and graphics processing for output to a display 130. The individual elements of block diagram 100 are now described in more detail.

As shown in FIG. 1, block diagram 100 includes an application 102. Application 102 is an end-user application that requires both physics simulations and graphics processing capability. For example, the physics simulations and graphics processing capabilities may be used to perform video game computing. In this example, application 102 may be a video game application.

Application 102 communicates with API 104. Several APIs are available for use in the graphics processing context. APIs were developed as intermediaries between application software, such as application 102, and graphics hardware on which the application software runs. With new chipsets and even entirely new hardware technologies appearing at an increasing rate, it is difficult for application developers to take into account, and take advantage of, the latest hardware features. It is also becoming increasingly difficult to write applications specifically for each foreseeable set of hardware. APIs prevent applications from having to be too hardware-specific. The application can output graphics data and commands to the API in a standardized format, rather than directly to the hardware.

API 104 communicates with driver 106. Driver 106 is typically written by the manufacturer of the graphics hardware, and translates standard code received from API 104 into native format understood by the graphics hardware, such as GPU 108 and GPU 110. Driver 106 also accepts input to direct performance settings for the graphics hardware. Such input may be provided by a user, an application or a process. For example, a user may provide input by way of a user interface (UI), such as a graphical user interface (GUI), that is supplied to the user along with driver 106. In an embodiment, driver 106 provides an extension to a commercially available API, such as DirectX® or OpenGL®. The extension provides application 102 with a library of functions for causing one or more GPUs to perform physics simulations and graphics processing, as described in more detail below. Because the library of functions is provided as an extension, an existing API may be used in accordance with an embodiment of the present invention. In an embodiment, the library of functions is called ATIPhysicsLib developed by ATI Technology Inc. of Markham, Ontario, Canada. However, the present invention is not limited to this embodiment. Other libraries of functions for causing one or more GPUs to perform physics simulations and graphics processing may be used without deviating from the spirit and scope of the present invention.

In one embodiment, the graphics hardware includes two graphics processor units, a first GPU 108 and a second GPU 110. In other embodiments there can be less than two or more than two GPUs. In various embodiments, first GPU 108 and second GPU 110 are identical. In various other embodiments, first GPU 108 and second GPU 110 are not identical. The various embodiments, which include different configurations of a video processing system, will be described in greater detail below.

Driver 106 issues commands to first GPU 108 and second GPU 110. First GPU 108 and second GPU 110 may be graphics chips that each includes a shader and other associated hardware for performing physics simulations and graphics processing. In an embodiment, the commands issued by driver 106 cause first GPU 108 to perform physics simulations and cause second GPU 110 to process graphics. In an alternative embodiment, the commands issued by driver 106 cause first GPU 108 to perform both physics simulations and graphics processing.

When rendered frame data processed by first GPU 108 and/or second GPU 110 is ready for display it is sent to display 130. Display 130 comprises a typical display for visualizing frame data as would be apparent to a person skilled in the relevant art(s).

It is to be appreciated that block diagram 100 is presented for illustrative purposes only, and not limitation. Other implementations may be realized without deviating from the spirit and scope of the present invention. For example, an example implementation may include more than two GPUs. In such an implementation, physics simulation tasks may be executed by one or more GPUs and graphics processing tasks may be executed by one or more GPUs.

### III. An Example System for Performing Simultaneous Physics Simulations and Graphics Processing on One or More GPUs in Accordance with an Embodiment of the Present Invention

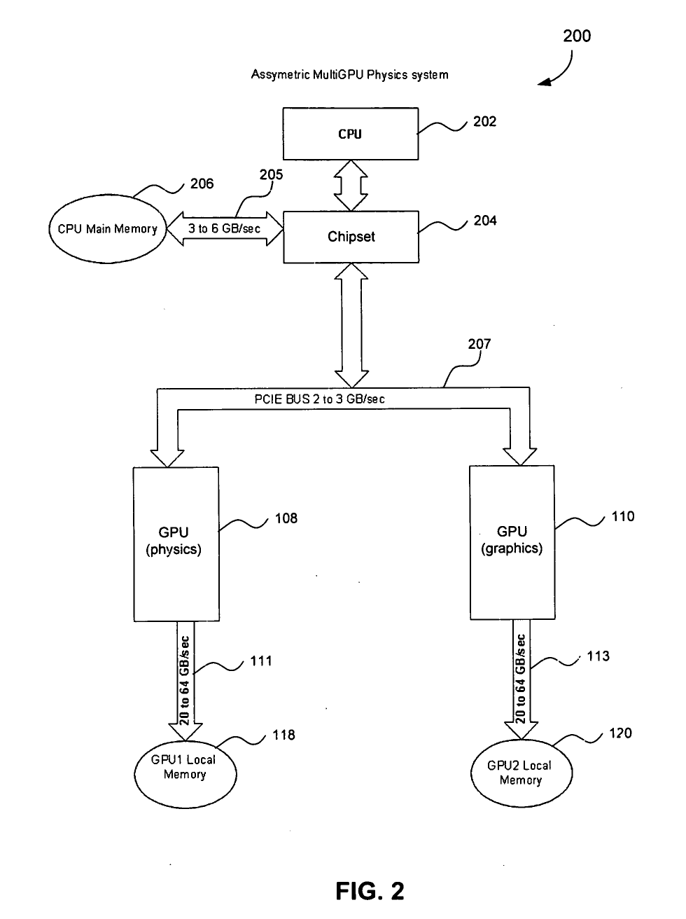

FIG. 2 depicts a block diagram of an example system 200 for simultaneously performing physics simulations and graphics processing in accordance with an embodiment of the present invention. System 200 includes components or elements that may reside on various components of a video-capable computer system. System 200 includes a CPU 202, a chip set 204, a CPU main memory 206, a physics GPU 108 coupled to a physics local memory 118, and a graphics GPU 110 coupled to a graphics local memory 120.

CPU 202 is a general purpose CPU that is coupled to a chip set 204 that allows CPU 202 to communicate with other components included in system 200. For example, chip set 204 allows CPU 202 to communicate with CPU main memory 206 via a memory bus 205. Memory bus 205 may have a bandwidth capacity of, for example, approximately 3 to 6 GB/sec. Chip set 204 also allows CPU 202 to communicate with physics GPU 108 and graphics GPU 110 via a peripheral component interface express (PCIE) bus 207. PCIE bus 207 may have a bandwidth capacity of, for example, approximately 3 to 6 GB/sec.

Physics GPU 108 is coupled to physics local memory 118 via a local connection 111 having a bandwidth of approximately 20 to 64 GB/sec. Similarly, graphics GPU 110 is coupled to graphics local memory 120 via a local connection 113 having a bandwidth of approximately 20 to 64 GB/sec.

In operation, CPU 202 performs general purpose processing operations as would be apparent to a person skilled in the relevant art(s). Physics simulation tasks are performed by physics GPU 108 and graphics processing tasks are performed by graphics GPU 110. Each of physics local memory 118 and graphics local memory 120 is mapped to a bus physical address space, as described in more detail below.

### IV. Scheme for Mapping Memory in a Multi-GPU Environment in Accordance with an Embodiment of the Present Invention

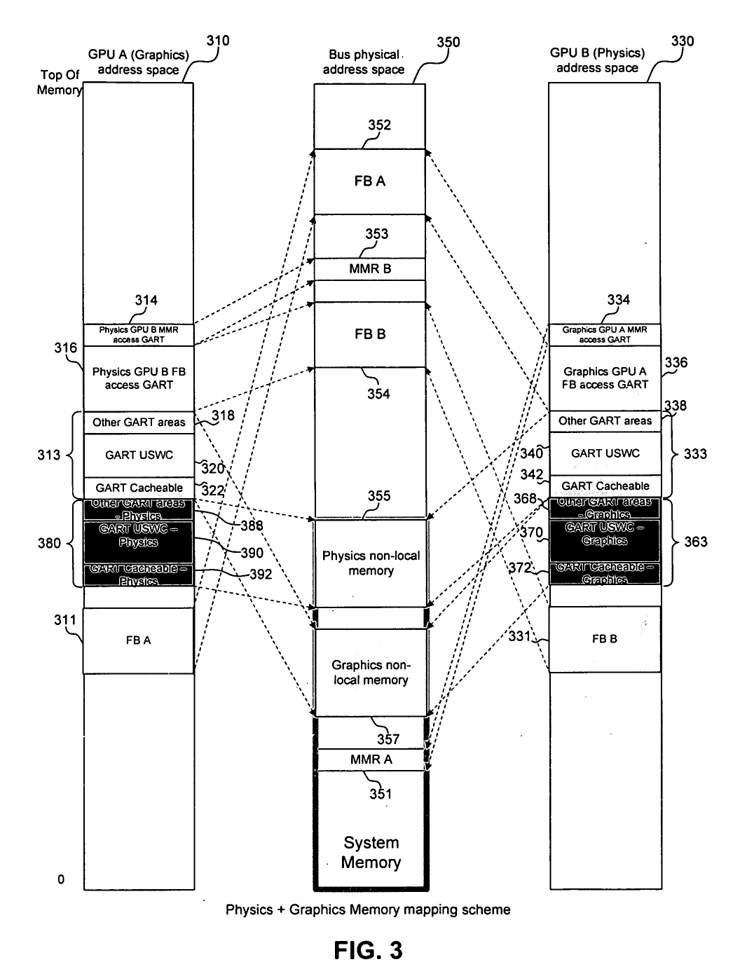

In an embodiment, physics GPU 108 and graphics GPU 110 can each read and write to a physics non-local memory (located, for example, in CPU main memory 206) and a graphics non-local memory (located, for example, in CPU main memory 206). For example, FIG. 3 depicts a diagram 300 illustrating a memory mapping scheme of a two GPU PCIE system in accordance with an embodiment of the present invention. Diagram 300 includes three address spaces: a graphics address space 310 corresponding to a graphics GPU A (similar to graphics GPU 110), a physics address space 330 corresponding to a physics GPU B (similar to physics GPU 108), and a bus physical address space 350.

In FIG. 3, the horizontally aligned areas of different GPU address spaces represent contiguous address spaces. That is, horizontally aligned address spaces in each GPU are mirror images of each other, including the same numerical addresses. As a result, the same command buffers are sent to each GPU, as described in more detail below. The physical memory being referenced by a particular address will depend on which GPU is executing the command buffer, due to the mapping scheme as described.

Graphics address space 310 includes a frame buffer A (FB A) address range 311 and a graphics address re-location table (GART) address range 313. FB A address range 311 contains addresses used to access the local memory of graphics GPU A for storing a variety of data including frame data, bit maps, vertex buffers, etc. FB A address range 311 corresponds to a typical memory included on a GPU, such as a memory comprising 64 megabytes, 128 megabytes, 256 megabytes, 512 megabytes, or some other larger or smaller memory as would be apparent to a person skilled in the relevant art(s). FB A address range 311 is mapped to FB A address range 352 of bus physical address space 350.

GART address range 313 is mapped to graphics non-local memory 357 of bus physical address space 350. GART address range 313 is divided into sub-address ranges, including a GART cacheable address range 322 (referring to cacheable data), a GART USWC address range 320 (referring to data with certain attributes, in this case, UnSpeculated, Write, Combine), and other GART address ranges 318.

In addition, a GART address range 380 is mapped to physics non-local memory 355 of bus address space 350. Similar to GART address range 313, GART address range 380 is divided into sub-address ranges, including a GART cacheable address range 392 (referring to cacheable physics data), a GART USWC address range 390 (referring to physics data with certain attributes, in this case, UnSpeculated, Write, Combine), and other GART address ranges 388.

Graphics address space 310 corresponding to graphics GPU A includes additional GART address ranges, including a physics GPU B FB access address range 316, and a physics GPU B MMR GART address range 314, that allow accesses to the local memory, and registers, of physics GPU B. Physics GPU B FB GART address range 316 allows graphics GPU A to write the memory of physics GPU B. In particular, Physics GPU B FB access GART address range 316 is mapped to local memory 354, which is mapped to FB B 331 of physics address space 330. Physics GPU B MMR access GART address range 314 allows access to memory mapped registers.

Similar to graphics address space 310, physics address space 330 includes a frame buffer B (FB B) address range 331 and a GART address range 333. FB B address range 331 contains addresses used to access the local memory of physics GPU B for storing a variety of data including physics simulations, bit maps, vertex buffers, etc. FB B address range 331 corresponds to a typical memory included on a GPU, such as a memory comprising 64 megabytes, 128 megabytes, 256 megabytes, 512 megabytes, or some other larger or smaller memory as would be apparent to a person skilled in the relevant art(s). FB B address range 331 is mapped to a FB B address range 354 of bus physical address space 350.

GART address range 333 is mapped to physics non-local memory 355 of bus physical address space 350. GART address range 333 is divided into sub-address ranges, including a GART cacheable address range 342 (referring to cacheable data), a GART USWC address range 340 (referring to data with certain attributes, in this case, UnSpeculated, Write, Combine), and other GART address ranges 338.

In addition, a GART address range 363 is mapped to graphics non-local memory 357 of bus address space 350. Similar to GART address range 333, GART address range 363 is divided into sub-address ranges, including a GART cacheable address range 372 (referring to cacheable graphics data), a GART USWC address range 370 (referring to graphics data with certain attributes, in this case, UnSpeculated, Write, Combine), and other GART address ranges 368.

Physics address space 330 corresponding to physics GPU B includes additional GART address ranges, including a graphics GPU A FB access address range 336, and a graphics GPU A MMR access address range 334, that allow accesses to the local memory, and registers, of graphics GPU A. Graphics GPU A FB access address range 336 allows physics GPU B to write the memory of graphics GPU A. In particular, graphics GPU A FB access address range 336 is mapped to local memory 352, which is mapped to FB A 311 of graphics address space 310. Graphics GPU A MMR access address range 334 allows access to memory mapped registers.

FB A address range 311 may be written to by other devices on the PCIE bus via FB A address range 352 on the bus physical address space, or bus address space, as previously described. This allows any device on the PCIE bus access to the local memory through FB A address range 311 of graphics address space 310 of graphics GPU A. In addition, according to an embodiment, FB A 352 is mapped into graphics GPU A FB access GART 336. This allows physics GPU B to access FB A address range 311 through its own GART mechanism, which points to FB A address range 352 in the bus address space 350 as shown. Therefore, if physics GPU B needs to access the local memory of graphics GPU A, it first goes through graphics GPU A FB access GART 336 in physics address space 330 which maps to FB A address range 352 in bus address space 350. FB A address range 352 in bus address space 350, in turn, maps to FB A address range 311 in graphics address space 310 corresponding to graphics GPU A.

Similarly, FB B address range 331 may be written to by other devices on the PCIE bus via the bus physical address space 350, or bus address space, as previously described. This allows any device on the PCIE bus to write to the local memory through FB B address range 331 of physics address space 330 of physics GPU B. In addition, according to an embodiment, FB B address range 331 is mapped into physics GPU B FB access GART address range 316 of graphics address space 310 of graphics GPU A. This allows graphics GPU A to access FB B address range 331 through its own GART mechanism, which points to FB B address range 354 in bus address space 350 as shown. Therefore, if graphics GPU A needs to access the local memory of physics GPU B, it first goes through physics GPU B FB access GART address range 316 in graphics address space 310, which maps to FB B address range 354 in bus address space 350. FB B address range 354 in bus address space 350, in turn, maps to FB B address range 331 in physics address space 330 of physics GPU B.

In addition to each GPU GART address range for accessing the FB of the other GPU, each GPU GART address range includes an address range for accessing memory mapped registers (MMR) of the other GPU. Graphics address space 310 of graphics GPU A has a GART address range that includes physics GPU B MMR access GART address range 314. Similarly, physics address space 330 of physics GPU B has a GART address range that includes graphics GPU A MMR access GART address range 334. Each of these MMR GART address ranges point to a corresponding MMR address range—namely, MMR A 351 and MMR B 353—in bus address range 350, which allows each GPU to access the other's memory mapped registers via the PCIE bus.

A typical multi-GPU mapping scheme includes a single shared non-local memory, or system memory, to which each GPU writes. In contrast, the memory mapping scheme illustrated in FIG. 3 includes two task specific non-local memories. An example advantage of this memory mapping scheme is that data relating to one task will not be over-written by data relating to another task. For example, physics simulation data will not be written over graphics processing data because each type of data will be stored in a task specific non-local memory. Other example advantages of this memory mapping scheme will become apparent to a person skilled in the relevant art(s) from reading the description contained herein.

Details of the two task specific non-local memories are now described. The system memory of bus physical address space 350 includes physics non-local memory 355 and graphics non-local memory 357. Both graphics GPU A and physics GPU B can access graphics non-local memory 357 and physics non-local memory 355 of bus physical address space 350. Graphics GPU A access graphics non-local memory 357 via GART address range 313 and access physics non-local memory 355 via GART address range 380. Physics GPU B access physics non-local memory 355 via GART address range 333 and access graphics non-local memory 357 via GART address range 363.

The memory mapping scheme illustrated in FIG. 3 allows for flexibility in how data is transferred between the GPUs because each GPU may transfer data to the other GPU in one of two ways. First, each GPU may write to the local memory of the other GPU. For example, physics GPU B may write to FB A address range 311 of graphics GPU A address space 310 by using the GART mechanism included in graphics GPU A FB access GART address range 336 of physics GPU B address space 330. Second, each GPU may write to the non-local task-specific memory of the other GPU. For example, physics GPU B may write to graphics non-local memory 357 on bus physical address space 350.

The flexibility of the memory mapping scheme illustrated in FIG. 3 allows data to be transferred in a manner that is most desirable for a given situation. In certain situations, it may be desirable for a GPU to write to the non-local memory of the other GPU. For example, in some situations a GPU cannot write to the local memory of the other GPU because the chipset included in the computer system does not support such a functionality (referred to as “PCIE peer-to-peer write”). In such situations, the memory mapping scheme illustrated in FIG. 3 still allows the GPUs to transfer data between each other because each GPU can write to the task-specific non-local memory of the other GPU. In certain other situations, it may be desirable for a GPU to write to the local memory of the other GPU. For example, transferring data between the GPUs by using the local memories is faster than using the non-local memory for at least two reasons. First, the GPU that writes the data can write to the local memory of the other GPU faster than it can write to the non-local memory of the other GPU. Second, a GPU can read the contents of its local memory faster than it can read the contents of its non-local memory. Thus, the memory mapping scheme illustrated in FIG. 3 allows for optimal flexibility in transferring data between the GPUs.

### V. Example Mechanism for Synchronizing Execution of Commands in Accordance with an Embodiment of the Present Invention

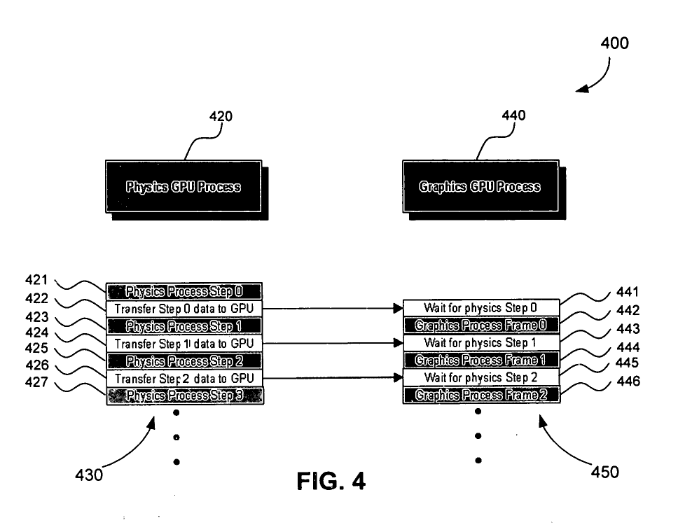

FIG. 4 depicts a block diagram 400 illustrating an example mechanism for synchronizing the execution of commands between physics GPU 108 and graphics GPU 110. As illustrated in FIG. 4, block diagram 400 includes a physics GPU process 420 that receives commands from a command buffer 430 and a graphics GPU process 440 that receives commands from a command buffer 450. It is to be appreciated, however, that block diagram 400 is shown for illustrative purposes only, and not limitation. Variations to the command synchronization technique described herein will become apparent to persons skilled in the relevant art(s). Such variations are within the scope and spirit of embodiments of the present invention. For example, a plurality of GPUs may be employed to execute commands within command buffer 430—i.e., a plurality of GPUs may be employed to execute physics simulation tasks. Similarly, a plurality of GPUs may be employed to execute commands within command buffer 450—i.e., a plurality of GPUs may be employed to execute graphics processing tasks.

In physics GPU process 420, physics simulations are performed in an iterative process, such that results of a first simulation step are passed as input to a second simulation step. In addition, the results of each simulation step is used as input to graphics GPU process 440. Although the physics simulations are performed iteratively, the graphics processing is performed in parallel with the physics simulations, thereby enabling an end-user to receive an enhanced gaming experience. These ideas will be illustrated with reference to FIG. 4.

In a first line 421 of physics GPU process 420, physics GPU 108 executes a physics process step 0. In a second line 422, data from step 0 is transferred to graphics GPU 110. Graphics GPU process 440 waits for the data from step 0, as indicated by line 441 of command buffer 450. After receiving the data from step 0, graphics GPU process 440 processes a frame 0, as indicated in line 442 of command buffer 450.

At the same time that graphics GPU process 440 is processing frame 0, physics GPU process 420 executes a physics process step 1, as indicated by line 423 of command buffer 430. Data from step 1 is transferred to graphics GPU 110, as indicated by line 424. Graphics GPU process 440 waits for the data from step 1, as indicated by line 443 of command buffer 450. After receiving the data from step 1, graphics GPU process 440 processes a frame 1, as indicated in line 444 of command buffer 450.

At the same time that graphics GPU process 440 is processing frame 1, physics GPU process 420 executes a physics process step 2, as indicated by line 425 of command buffer 430. Data from step 2 is transferred to graphics GPU 110, as indicated by line 426. Graphics GPU process 440 waits for the data from step 2, as indicated by line 445 of command buffer 450. After receiving the data from step 2, graphics GPU process 440 processes a frame 2, as indicated in line 446 of command buffer 450.

The simultaneous execution of physics simulation tasks and graphics processing tasks continues in a similar manner to that described above.

### VI. Example GPU Architecture for Performing Simultaneous Physics Simulations and Graphics Processing on One or More GPUs in Accordance with an Embodiment of the Present Invention

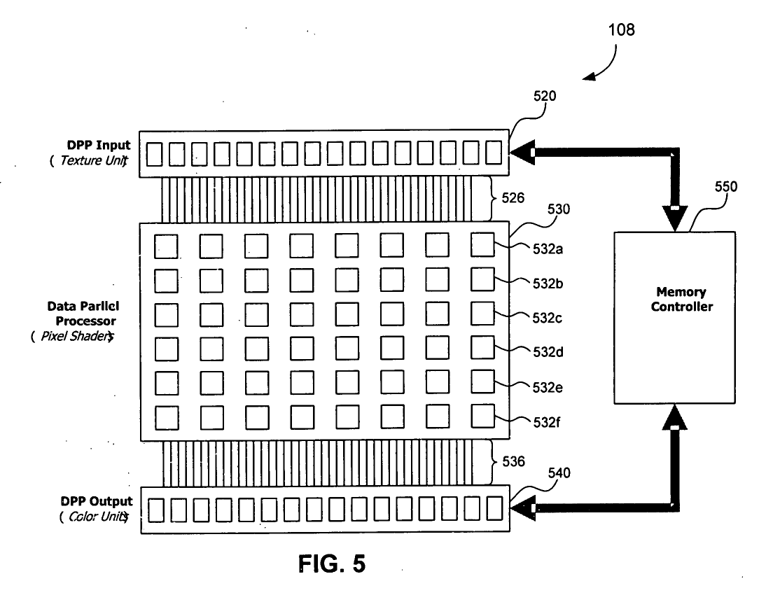

FIG. 5 depicts a block diagram illustrating an example GPU architecture of physics GPU 108 that performs physics simulations in accordance with an embodiment of the present invention. As illustrated in FIG. 5, GPU 108 includes a memory controller 550, a data parallel processor (DPP) 530, a DPP input 520, and a DPP output 540.

DPP input 520 is an input buffer that temporarily stores input data. DPP input 520 is coupled to memory controller 550 which retrieves the input data from video memory. For example, the input data may be retrieved from physics local memory 118 illustrated in FIG. 2. The input data is sent to DPP 530 via input lines 526.

DPP 530 includes a plurality of pixel shaders, including shaders 532a-f. Generally speaking, the plurality of pixel shaders execute processes on the input data. In GPU 108, the pixel shaders 532 execute the physics simulation tasks, whereas in GPU 110, similar pixel shaders execute the graphics processing tasks. The results of the processes executed by pixel shaders 532 are sent to DPP output 540 via output lines 536.

DPP output 540 is an output buffer that temporarily stores the output of DPP 530. DPP output 540 is coupled to memory controller 550 which writes the output data to video memory. For example, the output data may be written to physics local memory 118 illustrated in FIG. 2.

In an embodiment, graphics GPU 110 includes substantially similar components to physics GPU 108 described above. In this embodiment, memory controller 550 would be coupled to graphics local memory 120, not physics local memory 118 as is the case for physics GPU 108.

### VII. Example Software for Performing Simultaneous Physics Simulations and Graphics Processing on One or More GPUs in Accordance with an Embodiment of the Present Invention

As mentioned above with reference to FIG. 2, driver 106 converts code from API 104 into instructions that cause GPU 108 and/or GPU 110 to execute processes in accordance with an embodiment of the present invention, such as simultaneously executing physics simulations and graphics processing. In an embodiment, application 102 (such as a D3D application) accesses these processes by using a library of functions provided by driver 106. The library of functions may be implemented as an extension to an existing API, such as DirectX® or OpenGL®. Described below is an example library of functions, called ATIPhysicsLib, developed by ATI Technologies Inc. of Markham, Ontario, Canada. This example library of functions is provided by the driver as an extension to an existing API. The present invention is not limited, however, to this example library of functions. As will be apparent to a person of ordinary skill from reading the description contained herein, other libraries of functions may be used without deviating from the spirit and scope of the present invention. For example, in an embodiment, the library of functions may be provided to the application by the API, and not the driver.

An example process for simultaneously executing physics simulations and graphics processing is now described. ATIPhysicsLib includes an object, referred to herein as CPhysics, that encapsulates all functions necessary to execute physics simulations and graphics processing tasks on one or more GPUs as described herein. Devices embodied in the one or more GPUs that execute physics simulations are enumerated by a constructor module. The constructor module then populates a data structures with information relating to the devices that execute physics simulations. After creation of a window which will be used as a focus window for graphics rendering, an application (such as application 102 of FIG. 1) calls a function, referred to herein as GetDeviceAvailableForPhysics, that identifies a device embodied in the one or more GPUs that can be used as a physics device. The GetDeviceAvailableForPhysics function returns a value that is later used as a parameter to create a physics device for executing physics simulation tasks.

After identifying a physics device, the application calls an Initialize function. The Initialize function performs initialization checks and may attach the physics device to the desktop. Note, however, that after the CPhysics object is destroyed, all attached devices will be detached.

After initializing the physics device, the application calls a function that creates a graphics device. Then, the application calls a function, referred to herein as CreatePhysicsDevice, that creates a physics device. Also, this function checks the configuration of the graphics device and the physics device to determine whether they are embodied in a single GPU or in more than one GPU. If the graphics device and the physics device are embodied in more than one GPU, the two devices execute commands in synchronization, as described above with reference to FIG. 4.

### VIII. Example Computer Implementation

Embodiments of the present invention (such as block diagram 100, system 200, physics GPU 108, graphics GPU 110, or any part(s) or function(s) thereof) may be implemented using hardware, software or a combination thereof and may be implemented in one or more computer systems or other processing systems. Useful machines for performing the operation of the present invention include general purpose digital computers or similar devices.

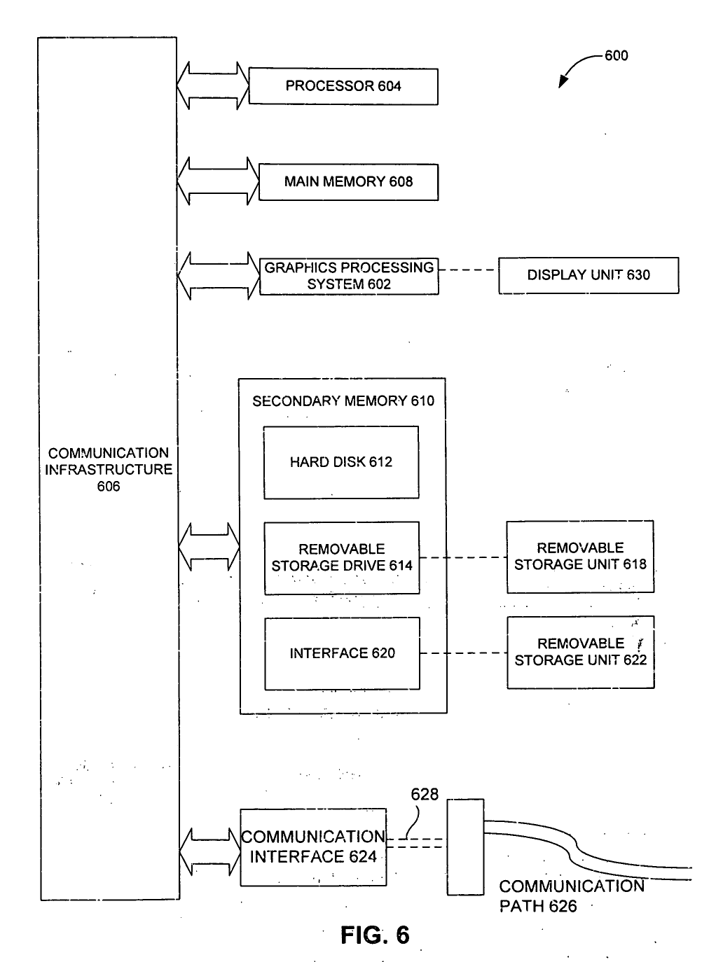

In fact, in one embodiment, the invention is directed toward one or more computer systems capable of carrying out the functionality described herein. An example of a computer system 600 is shown in FIG. 6.

The computer system 600 includes one or more processors, such as processor 604. Processor 604 may be a general purpose processor (such as CPU 202 of FIG. 2) or a special purpose processor (such as physics GPU 108 or graphics GPU 110). Processor 604 is connected to a communication infrastructure 606 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 600 can include a graphics processing system 602 which performs physics simulation and graphics processing tasks for rendering images to an associated display 630. Graphics processing system 602 may include the graphics hardware elements described above in reference to FIGS. 1 and 2, such as physics GPU 108 and graphics GPU 110, although the invention is not so limited. In an embodiment, graphics processing system 602 is configured to perform features of the present invention, such as the memory mapping of FIG. 3 and/or the command execution and synchronization of FIG. 4. Graphics processing system 602 may perform these steps under the direction of computer programs being executed by processor 604 and/or under the direction of computer programs being executed by one or more graphics processors within graphics processing system 602.

Computer system 600 also includes a main memory 608, preferably random access memory (RAM), and may also include a secondary memory 610. The secondary memory 610 may include, for example, a hard disk drive 612 and/or a removable storage drive 614, representing a floppy disk drive, a magnetic tape drive, an optical disk drive, etc. The removable storage drive 614 reads from and/or writes to a removable storage unit 618 in a well known manner. Removable storage unit 618 represents a floppy disk, magnetic tape, optical disk, etc. which is read by and written to by removable storage drive 614. As will be appreciated, the removable storage unit 618 includes a computer usable storage medium having stored therein computer software and/or data.

In alternative embodiments, secondary memory 610 may include other similar devices for allowing computer programs or other instructions to be loaded into computer system 600. Such devices may include, for example, a removable storage unit 622 and an interface 620. Examples of such may include a program cartridge and cartridge interface (such as that found in video game devices), a removable memory chip (such as an erasable programmable read only memory (EPROM), or programmable read only memory (PROM)) and associated socket, and other removable storage units 622 and interfaces 620, which allow software and data to be transferred from the removable storage unit 622 to computer system 600.

Computer system 600 may also include a communications interface 624. Communications interface 624 allows software and data to be transferred between computer system 600 and external devices. Examples of communications interface 624 may include a modem, a network interface (such as an Ethernet card), a communications port, a Personal Computer Memory Card International Association (PCMCIA) slot and card, etc. Software and data transferred via communications interface 624 are in the form of signals 628 which may be electronic, electromagnetic, optical or other signals capable of being received by communications interface 624. These signals 628 are provided to communications interface 624 via a communications path (e.g., channel) 626. This channel 626 carries signals 628 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 614, a hard disk installed in hard disk drive 612, and signals 628. These computer program products provide software to computer system 600. The invention is directed to such computer program products.

Computer programs (also referred to as computer control logic) are stored in main memory 608 and/or secondary memory 610. Computer programs may also be received via communications interface 624. Such computer programs, when executed, enable the computer system 600 to perform the features of the present invention, as discussed herein. In particular, the computer programs, when executed, enable the processor 604 to perform the features of the present invention. Accordingly, such computer programs represent controllers of the computer system 600.

In an embodiment where the invention is implemented using software, the software may be stored in a computer program product and loaded into computer system 600 using removable storage drive 614, hard drive 612 or communications interface 624. The control logic (software), when executed by the processor 604, causes the processor 604 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

In addition to hardware implementations of physics GPU 108 and graphics GPU 110, such GPUs may also be embodied in software disposed, for example, in a computer usable (e.g., readable) medium configured to store the software (e.g., a computer readable program code). The program code causes the enablement of embodiments of the present invention, including the following embodiments: (i) the functions of the systems and techniques disclosed herein (such as performing physics simulations on a first GPU and graphics processing on a second GPU); (ii) the fabrication of the systems and techniques disclosed herein (such as the fabrication of physics GPU 108 and graphics GPU 110); or (iii) a combination of the functions and fabrication of the systems and techniques disclosed herein. For example, this can be accomplished through the use of general programming languages (such as C or C++), hardware description languages (HDL) including Verilog HDL, VHDL, Altera HDL (AHDL) and so on, or other available programming and/or schematic capture tools (such as circuit capture tools). The program code can be disposed in any known computer usable medium including semiconductor, magnetic disk, optical disk (such as CD-ROM, DVD-ROM) and as a computer data signal embodied in a computer usable (e.g., readable) transmission medium (such as a carrier wave or any other medium including digital, optical, or analog-based medium). As such, the code can be transmitted over communication networks including the Internet and internets. It is understood that the functions accomplished and/or structure provided by the systems and techniques described above can be represented in a core (such as a GPU core) that is embodied in program code and may be transformed to hardware as part of the production of integrated circuits.

### X. Conclusion

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

What is claimed is:

1. A method for performing physics simulations and graphics processing on at least one graphics processor unit (GPU), comprising:
executing physics simulations on a first device embodied in the at least one GPU; and
processing graphics on a second device embodied in the at least one GPU responsive to the physics simulations executed on the first device.

2. The method of claim 1, wherein:
the executing comprises executing physics simulations on a first device embodied in a first GPU; and
the processing comprises processing graphics on a second device embodied in the first GPU responsive to the physics simulations executed on the first device.

3. The method of claim 1, wherein:
the executing comprises executing physics simulations on a first device embodied in a first GPU; and
the processing comprises processing graphics on a second device embodied in a second GPU responsive to the physics simulations executed on the first device.

4. The method of claim 3, wherein executing physics simulations on a first device embodied in a first GPU comprises:
sequentially executing physics processes on the first device embodied in the first GPU, such that a first physics process is executed during a first time interval and a second physics process is executed during a second time interval responsive to a result of the first physics process.

5. The method of claim 4, wherein processing graphics on a second device embodied in a second GPU responsive to the physics simulations executed on the first device comprises:
receiving the result of the first physics process; and
executing a graphics process on the second device embodied in the second GPU during the second time interval responsive to the result of the first physics process.

6. The method of claim 4, wherein processing graphics on a second device embodied in a second GPU responsive to the physics simulations executed on the first device comprises:
retrieving the result of the first physics process from a local memory of the second GPU; and
executing a graphics process on the second device embodied in the second GPU during the second time interval based on the result retrieved from the local memory of the second GPU.

7. The method of claim 4, wherein processing graphics on a second device embodied in a second GPU responsive to the physics simulations executed on the first device comprises:
retrieving the result of the first physics process from a non-local memory corresponding to the second GPU; and
executing a graphics process on the second device embodied in the second GPU during the second time interval based on the result retrieved from the non-local memory corresponding to the second GPU.

8. The method of claim 1, further comprising:
writing the physics simulations to a shared resource.

9. The method of claim 7, further comprising:
retrieving the physics simulations from the shared resource.

10. A computer readable medium containing instructions for generating at least one graphics processor unit (GPU) which when executed are adapted to create the at least one GPU, wherein the at least one GPU is adapted to:
execute physics simulations on a first device embodied in the at least one GPU; and
process graphics on a second device embodied in the at least one GPU responsive to the physics simulations executed on the first device.

11. The computer readable medium of claim 10, wherein the first device that executes the physics simulations and the second device that processes the graphics are embodied in a single GPU.

12. The computer readable medium of claim 10, wherein the first device that executes the physics simulations is embodied in a first GPU and the second device that processes the graphics is embodied in a second GPU.

13. The computer readable medium of claim 12, wherein the first GPU is adapted to sequentially execute physics processes, such that a first physics process is executed during a first time interval and a second physics process is executed during a second time interval responsive to a result of the first physics process.

14. The computer readable medium of claim 13, wherein the second GPU is adapted to:
receive the result of the first physics process; and
execute a graphics process during the second time interval responsive to the result of the first physics process.

15. The computer readable medium of claim 13, wherein the second GPU is adapted to:
retrieve the result of the first physics process from a local memory of the second GPU; and
execute a graphics process on the second device embodied in the second GPU during the second time interval based on the result retrieved from the local memory of the second GPU.

16. The computer readable medium of claim 13, wherein the second GPU is adapted to:
retrieve the result of the first physics process from a non-local memory corresponding to the second GPU; and
execute a graphics process on the second device embodied in the second GPU during the second time interval based on the result retrieved from the non-local memory corresponding to the second GPU.

17. The computer readable medium of claim 10, wherein the at least one GPU is further adapted to:
write the physics simulations to a shared resource.

18. The computer readable medium of claim 15, wherein the at least one GPU is further adapted to:
retrieve the physics simulations from the shared resource.

19. The computer readable medium of claim 10, wherein the at least one GPU is embodied in hardware description language software.

20. The computer readable medium of claim 19, wherein the at least one GPU is embodied in one of Verilog hardware description language software and VHDL hardware description language software.

21. A computer program product comprising computer usable medium having control logic stored therein for causing physics simulations and graphics processing to be performed on at least one graphics processor unit (GPU), the control logic comprising:
first computer readable code for causing the at least one GPU to execute physics simulations on a first device embodied in the at least one GPU; and
second computer readable code for causing the at least one GPU to process graphics on a second device embodied in the at least one GPU responsive to the physics simulations executed on the first device.

22. The computer program product of claim 21, wherein the first device that executes the physics simulations and the second device that processes graphics are embodied in a single GPU.

23. The computer program product of claim 21, wherein the first device that executes the physics simulations is embodied in a first GPU and the second device that processes the graphics is embodied in a second GPU.

24. The computer program product of claim 23, further comprising:
code for causing the first GPU to sequentially execute physics processes, such that a first physics process is executed during a first time interval and a second physics process is executed during a second time interval responsive to a result of the first physics process.

25. The computer program product of claim 24, further comprising:
code for causing the second GPU to receive the result of the first physics process; and
code for causing the second GPU to execute a graphics process during the second time interval responsive to the result of the first physics process.

26. The computer program product of claim 24, further comprising:
code for causing the second GPU to retrieve the result of the first physics process from a local memory of the second GPU; and
code for causing the second GPU to execute a graphics process during the second time interval based on the result retrieved from the local memory of the second GPU.

27. The computer program product of claim 24, further comprising:
code for causing the second GPU to retrieve the result of the first physics process from a non-local memory corresponding to the second GPU; and
code for causing the second GPU to execute a graphics process during the second time interval based on the result retrieved from the non-local memory corresponding to the second GPU.

28. The computer program product of claim 21, further comprising:
third computer readable code for writing the physics simulations to a shared resource.

29. The computer program product of claim 28, further comprising:
fourth computer readable code for retrieving the physics simulations from the shared resource.

30. A method for performing physics simulations and graphics processing tasks on at least one graphics processing unit (GPU), comprising:
providing an application with a physics thread for executing physics simulations and a graphics thread for executing graphics processing; and
executing the physics thread and the graphics thread on at least one GPU.

31. The method of claim 30, wherein the executing comprises:
executing the physics thread on a first GPU and the graphics thread on a second GPU.
